(19) United States
(12) Patent Application Publication
(10) Pub. No.: US 2011/0143881 A1
(43) Pub. Date: Jun. 16, 2011

(54) CONICAL FRICTION RING TYPE CONTINUOUSLY VARIABLE TRANSMISSION DEVICE

(75) Inventors: Mitsugi YAMASHITA, Anjo (JP); Shoji TAKAHASHI, Okazaki (JP); Hideyuki UMEDA, Ciryu (JP)

(73) Assignee: AISIN AW CO., LTD., ANJO-SHI (JP)

(21) Appl. No.: 12/911,770

(22) Filed: Oct. 26, 2010

(30) Foreign Application Priority Data
Dec. 10, 2009 (JP) 2009-280744

(51) Int. Cl. F16H 15/04

(52) U.S. Cl. 476/7

(57) ABSTRACT

A conical friction ring type continuously variable transmission device configured a ring is provided such that it is interposed between opposing inclined surfaces of a first and second conical friction wheels so as to surround the first conical friction wheel. In this configuration, power is transmitted by contact between the ring and the first and second conical friction wheels, which moves the ring in the axial direction to steplessly change speed. A portion of the ring is submerged in an oil reservoir in a lower portion of the space when the ring is moved to any position in the axial direction. An oil guide is disposed on an axial partial region on the small diameter side of the first conical friction wheel, and guides oil raked up from the oil reservoir due to the rotation of the ring toward the first conical friction wheel.

### INCORPORATION BY REFERENCE

The disclosure of Japanese Patent Application No. 2009-280744 filed on Dec. 10, 2009 including the specification, drawings and abstract is incorporated herein by reference in its entirety.

### BACKGROUND OF THE INVENTION

The present invention relates to a conical friction ring type continuously variable transmission device that has a pair of conical friction wheels disposed mutually parallel and disposed such that a large diameter side and a small diameter side are opposite each other in an axial direction; and a ring that is provided interposed between opposing inclined surfaces of the friction wheels, wherein the ring is moved in the axial direction to steplessly change a speed. More specifically, the present invention relates to an oil guide structure that guides oil to the conical friction wheels.

### DESCRIPTION OF THE RELATED ART

A known conical friction ring type continuously variable transmission device (also called a cone ring type continuously variable transmission device) has a conical friction wheel serving as an input side, a conical friction wheel serving as an output side, and a metal ring that is provided interposed between opposing inclined surface of the friction wheels so as to surround the input-side friction wheel. Axes of the friction wheels are disposed parallel, and large diameter portions and small diameter portions of the friction wheels are disposed respectively opposite each other. The cone ring type continuously variable transmission device steplessly changes a speed by moving the ring in an axial direction.

The cone ring type continuously variable transmission device described above transmits power by applying a large axial force that corresponds to a transmission torque or the like under an oil environment such as traction oil, such that a large contact pressure acts on a contact portion between the ring and the friction wheels with an oil film interposed therebetween.

For this reason, the cone ring type continuously variable transmission device is accommodated inside an oil-tight space. A part of the ring and the friction wheels is submerged in oil that is sealed inside the space. Oil is raked up by the rotation of the ring and the friction wheels, and supplied to friction contact portions. A cone ring type continuously variable transmission device that is provided with an oil guide (fluid medium supply body) that guides oil raked up by the rotation of the ring and the friction wheels to the friction contact portions has also been proposed (see Published Japanese Translation of PCT Application No. 2009-506279 (see FIGS. 10, 15 to 17)).

### SUMMARY OF THE INVENTION

The oil guide includes an oil guide (fluid medium supply body 1201) having a plate structure that is disposed facing from an oil reservoir toward a contact portion between the ring and the friction wheels; and an oil guide (fluid medium supply body 1220) that is disposed above the friction wheels, and deflects and returns the raked up oil to the input-side friction wheel. The oil guide (1201) from the oil reservoir is disposed over the entire axial length of the conical friction wheels. The oil guide (1220) for deflecting and returning oil, which is disposed above the oil guide (1201) and forms a pair therewith, is also disposed over the entire axial length of the conical friction wheels.

The conical friction wheels are dipped in the oil reservoir, and oil is directly raked up and supplied by the rotation of the friction wheels.

The oil guide provided substantially over the entire axial length comes with disadvantages in terms of the large size of the oil guide itself, as well as in terms of cost and installation space. In addition, the input-side friction wheel and the output-side friction wheel are dipped in the oil reservoir and experience rotational resistance due to the oil. In the case of friction oil in particular, the rotation of the friction wheels causes the friction oil to generate a large shear force, which may lower transmission efficiency.

Hence, it is an object of the present invention to provide a conical friction ring type continuously variable transmission device that resolves the above problems by disposing an oil guide in only a partial region on a small diameter side of a conical friction wheel where there tends to be insufficient oil.

According to a first aspect of the present invention, an oil guide is disposed only in an axial partial region on a small diameter side of a first conical friction wheel. Therefore, the oil guide is disposed on a portion with play in terms of space on a small diameter-side portion of the conical friction wheel, and there is no interference when installed with a shift operation member that moves a ring. Thus, a continuously variable transmission device does not increase in size, and the oil guide can be easily disposed.

The small diameter side of the conical friction wheel is separated from an oil reservoir, which is disadvantageous for raking up oil with the ring, and oil tends to flow toward a large diameter side along an outer circumferential surface due to a centrifugal force. In addition, the first conical friction wheel positioned on an inner diameter side of the ring is at a disadvantage for supplying oil from the ring. However, oil raked up by the ring is reliably supplied by the oil guide to a contact surface between the ring and the first conical friction wheel so that smooth and reliable power transmission and shifting can be achieved.

According to a second aspect of the present invention, oil raked up by the ring is dropped onto the conical friction wheel by an upper oil guide, which is disposed along an outer diameter side of a movement path of the ring above the conical friction wheel. In addition, the oil is maintained on the conical friction wheel by a side oil guide, which is disposed along an inclined surface of the conical friction wheel offset sideward of the conical friction wheel inside the ring. Therefore, oil can be reliably supplied to the contact surface between the ring and the conical friction wheel.

According to a third aspect of the present invention, the first conical friction wheel has a portion in the axial direction on the large diameter side submerged in the oil reservoir. Oil from the oil reservoir is directly supplied to the conical friction wheel on the large diameter side, and oil is supplied by the oil guide on the small diameter side, such that oil is accurately supplied to the first conical friction wheel over an entire shift range. Thus, smooth power transmission and shifting can be achieved. In addition, a relatively small portion of the conical friction wheel is submerged in the oil reservoir, and the first conical friction wheel experiences little rotational resistance from the oil. Consequently, a reduction in transmission efficiency due to power loss can be decreased.

According to a fourth aspect of the present invention, the axial partial region provided with the oil guide corresponds to a position at which the first conical friction wheel is not submerged in the oil reservoir. Therefore, an axial length of the oil guide is minimized, and an oil supply to a ring contact portion can be secured while also achieving a more compact continuously variable transmission device.

According to a fifth aspect of the present invention, a second conical friction wheel is disposed above the first conical friction wheel, and the second conical friction wheel is also disposed such that an entire axial length thereof is not submerged in the oil reservoir. Therefore, the second conical friction wheel experiences no rotational resistance caused by the oil reservoir, and a reduction in transmission efficiency can be suppressed. In addition, a case is disposed so as to surround the second conical friction wheel, and the conical- and cylindrical-shaped case serves as a guide to lead oil to the second conical friction wheel. This consequently secures an oil supply for the second conical friction wheel, and increases the compactness of the case, and by extension, a cone ring type continuously variable transmission device.

According to a sixth aspect of the present invention, the first conical friction wheel surrounded by the ring is an input-side friction wheel. Therefore, on a deceleration side, the small diameter side is the portion of the input-side friction wheel contacting the ring. In a region with a large load torque on a high deceleration (U/D) side of the input-side friction wheel, oil can be supplied to the small diameter side by the oil guide.

According to a seventh aspect of the present invention, a traction oil is provided interposed between the contact surfaces of the conical friction wheel and the ring, and torque can be reliably transferred through a shear force of the traction oil in an extreme pressure condition. Once a rotation member is dipped in the traction oil, a large shear resistance is generated between the rotation member and the traction oil. However, the portion of the rotation member submerged in the traction oil is minimized to an axial portion on the large diameter side of the first conical friction wheel on the outside of the ring. Therefore, there is little power loss due to oil resistance.

### BRIEF DESCRIPTION OF THE DRAWINGS

FIG. 1 is an interior cross-sectional view that shows a hybrid drive system to which the present invention is applied;

FIG. 2 is a frontal view that shows a conical friction ring (cone ring) type continuously variable transmission device according to the present invention; and

FIG. 3 is a left side view of the conical friction ring (cone ring) type continuously variable transmission device.

### DETAILED DESCRIPTION OF THE EMBODIMENT

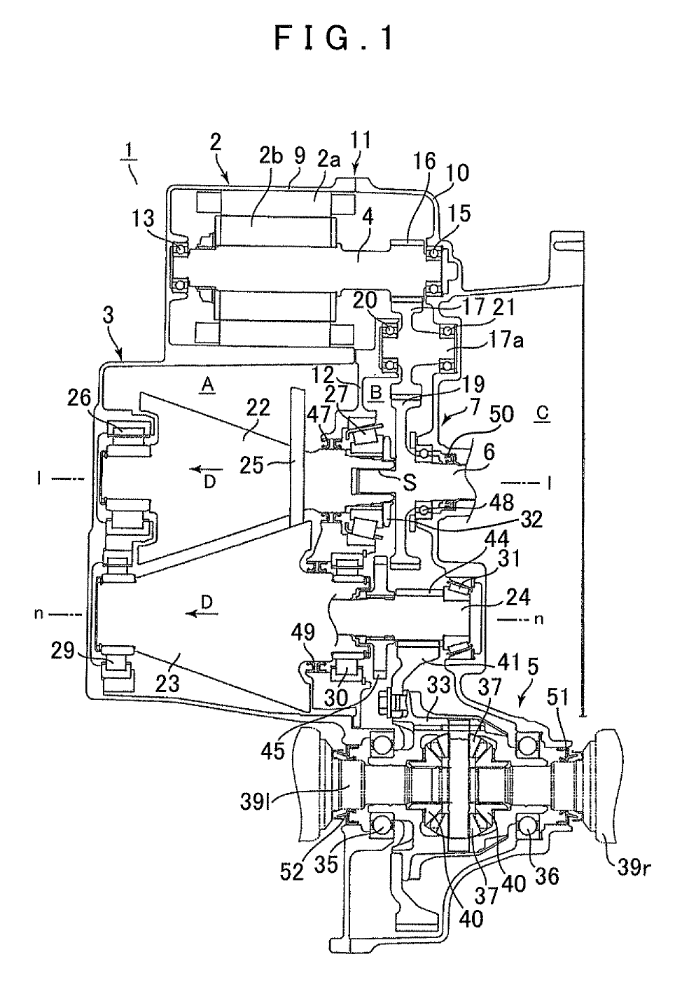

A hybrid drive system to which the present invention is applied will be described below with reference to the attached drawings. As shown in FIG. 1, a hybrid drive system 1 includes an electric motor 2, a cone ring type continuously variable transmission device (a conical friction ring type continuously variable transmission device) 3, a differential device 5, an input shaft 6 that moves in accordance with an output shaft of an engine (not shown), and a gear transmission device 7. The above devices and shafts are housed in a case 11 that is formed by two case members, that is, a case member 9 and a case member 10. Further, the case 11 includes a first space A and a second space B divided by a partition 12 in an oil-tight manner.

The electric motor 2 includes a stator 2a fixed to the first case member 9, and a rotor 2b provided on an output shaft 4. A first-side end portion of the output shaft 4 is rotatably supported by the first case member 9 through a bearing 13, and a second-side end portion of the output shaft 4 is rotatably supported by the second case member 10 through a bearing 15. An output gear 16 consisting of a toothed gear (pinion) is formed on a second side of the output shaft 4, and meshes with an intermediate gear (toothed gear) 19 provided on the input shaft 6 through a toothed idler gear 17.

A shaft 17a of the toothed idler gear 17 includes a first-side end portion that is rotatably supported by the partition 12 through a bearing 20, and a second-side end portion that is rotatably supported by the second case member 10 through a bearing 21. The toothed idler gear 17 is disposed partially overlapping with the electric motor 2 in a radial direction when viewed from the side (that is, when viewed in an axial direction).

The cone ring type continuously variable transmission device 3 includes a conical (first conical) friction wheel 22 serving as an input member, a conical (second conical) friction wheel 23 serving as an output member, and a ring 25 made of metal. The friction wheels 22, 23 are disposed such that axes l-l, n-n thereof are mutually parallel, and a small diameter side and a large diameter side of the friction wheel 22 are disposed axially opposite to a small diameter side and a large diameter side of the friction wheel 23. The ring 25 is interposed between opposing inclined surfaces of the friction wheels 22, 23 and surrounds one of the friction wheels, for example, the input-side friction wheel 22. A large thrust force acts on at least one of the friction wheels, and therefore the ring 25 is interposed between the inclined surfaces by a relatively large clamping force based on this thrust force. Specifically, an axial force application mechanism (not shown) formed of a wave-like cam is formed between the output-side friction wheel 23 and an output shaft 24 of the continuously variable transmission device, on surfaces opposed to each other in the axial direction. The thrust force in a direction shown by an arrow D is generated in accordance with the transferred torque on the output-side friction wheel 23, and a large clamping force is generated to act on the ring 25 between the output-side friction wheel 23 and the input-side friction wheel 22 that is supported in a direction that counters the thrust force.

The input-side friction wheel 22 includes a first-side (large diameter-side) end portion supported by the first case member 9 through a roller bearing 26, and a second-side (small diameter-side) end portion supported by the partition 12 through a tapered roller bearing 27. The output-side friction wheel 23 includes a first-side (small diameter-side) end portion supported by the first case member 9 through a roller (radial) bearing 29, and a second-side (large diameter-side) end portion supported by the partition 12 through a roller (radial) bearing 30. The output shaft 24, which applies to the output-side friction wheel 23 the thrust force acting in the direction shown by the arrow D as described above, includes a second-side end supported by the second case member 10 through a tapered roller bearing 31. An inner race of the bearing 27 is interposed between a stepped portion and a nut 32 on the second-side end portion of the input-side friction wheel 22, and the thrust force that acts on the input-side friction wheel 22 through the ring 25 in the direction shown by the arrow D from the output-side friction wheel 23 is supported by the tapered roller bearing 27. On the other hand, a reaction force of the thrust force acting on the output-side friction wheel 23 acts on the output shaft 24 in a direction opposite to the direction shown by the arrow D, and the reaction force of the thrust force is supported by the tapered roller bearing 31.

The ring 25 moves in the axial direction by an axial moving mechanism (a shift operation member), such as a ball screw, and changes the positions of contact with the input-side friction wheel 22 and the output-side friction wheel 23, so as to steplessly change the speed by steplessly changing a rotation ratio between the input member 22 and the output member 23. The thrust force D corresponding to the transferred torque and the reaction force of the thrust force are canceled out by the tapered roller bearings 27, 31 in the integrated case 11, and an equilibrant force such as a hydraulic pressure is not required.

The differential device 5 includes a differential case 33, and the differential case 33 includes a first-side end portion supported by the first case member 9 through a bearing 35, and a second-side end portion supported by the second case member 10 through a bearing 36. A shaft that is perpendicular to the axial direction is attached to the inside of the differential case 33, and bevel gears 37, 37, which serve as differential carriers, are engaged with the shaft. Left and right axle shafts 39l, 39r are supported by the shaft, and bevel gears 40, 40 that mesh with the differential carriers are fixed to the axle shafts. Further, a differential ring gear (toothed gear) 41 having a large diameter is attached to the outside of the differential case 33.

The output shaft 24 of the continuously variable transmission device is formed with a gear (pinion) 44, and the toothed gear 44 meshes with the differential ring gear 41. The motor output gear (pinion) 16, the toothed idler gear 17, the intermediate gear (toothed gear) 19, the output gear (pinion) 44 of the continuously variable transmission device, and the differential ring gear (toothed gear) 41 constitute the gear transmission device 7. The motor output gear 16 and the differential ring gear 41 are disposed overlapping each other in the axial direction, and the intermediate gear 19 and the output gear 44 of the continuously variable transmission device are disposed overlapping the motor output gear 16 and the differential ring gear in the axial direction. Note that, a gear 45, which is engaged with the output shaft 24 of the continuously variable transmission device through a spline, is a parking gear that locks the output shaft when a shift lever is in a parking position. Further, the term “gear” refers to a meshing rotary transmission mechanism including toothed gears and sprockets. In this embodiment, however, the gear transmission device is a toothed gear transmission device that is formed by toothed gears only.

The input shaft 6 is supported by the second case member 10 through a roller bearing 48. A first end of the input shaft 6 is engaged (drivingly connected) with the input member 22 of the continuously variable transmission device 3 through a spline S, and a second end side of the input shaft 6 is linked with the output shaft of the engine through a clutch (not shown) housed in a third space C defined by the second case member 10, so that the input shaft 6 moves in accordance with the output shaft of the engine. The second case member 10 is open and connected to the engine (not shown) on a third space C side.

The gear transmission device 7 is housed in the second space B. The second space B is a space between the third space C, and the electric motor 2 and the first space A, in the axial direction. The second space B is defined by the second case member 10 and the partition 12. The shaft-supporting portions (27, 30) of the partition 12 are placed in an oil-tight state by oil seals 47, 49, respectively, and the shaft-supporting portions of the second case member 10 and the first case member 9 are shaft-sealed by oil seals 50, 51, 52. The second space B is configured to be oil-tight, and is filled with a predetermined amount of a lubricant oil such as ATF. The first space A defined by the first case member 9 and the partition 12 is similarly configured to be oil-tight, and is filled with a predetermined amount of a traction oil having a shear force, and a large shear force under an extreme pressure condition in particular.

Next, the operation of the hybrid drive system 1 as described above will be explained. The hybrid drive system 1 is connected to an internal combustion engine on the third space C side of the case 11, and the output shaft of the engine is connected to the input shaft 6 through a clutch. The power from the engine is transmitted to the input shaft 6, and the rotation of the input shaft 6 is transmitted to the input-side friction wheel 22 in the cone ring type continuously variable transmission device 3 through the spline S. The power is further transmitted to the output-side friction wheel 23 through the ring 25.

During this transmission, a large contact pressure acts between the friction wheels 22, 23 and the ring 25 due to the thrust force acting on the output-side friction wheel 23 in the direction shown by the arrow D. Because the first space A is filled with the traction oil, an oil film of the traction oil is formed between the friction wheels and the ring, bringing about the extreme pressure condition. In this condition, the traction oil has a large shear force, and thus the power is transmitted between the friction wheels and the ring by the shear force of the oil film. This allows the transfer of a predetermined torque in a non-slip manner without causing wear on the friction wheels and the ring, even though the torque transfer is made through contact between metal members. Moreover, the ring 25 moves in the axial direction smoothly to change the positions of contact between both friction wheels and the ring, whereby the speed is steplessly changed.

The rotation of the output-side friction wheel 23 whose speed has been steplessly changed is transmitted to the differential case 33 of the differential device 5 through the output shaft 24, the output gear 44, and the differential ring gear 41. The power is then distributed to the left and right axle shafts 39l, 39r so as to drive the vehicle wheels (front wheels).

On the other hand, the power from the electric motor 2 is transmitted to the input shaft 6 through the output gear 16, the toothed idler gear 17, and the intermediate gear 19. Similar to the description above, the speed of the rotation of the input shaft 6 is steplessly changed by the cone ring type continuously variable transmission device 3, and the rotation is transmitted to the differential device 5 through the output gear 44 and the differential ring gear 41. The gear transmission device 7 formed by the gears 16, 17, 19, 44, 41, 37, 40 is housed in the second space B filled with the lubricant oil, and therefore the power is smoothly transmitted through the lubricant oil when the gears mesh. At such time, because the differential ring gear 41 disposed at a lower position in the second space B is formed of a large diameter gear, the differential ring gear 41 rakes up the lubricant oil so that a sufficient amount of lubricant oil is reliably supplied to the other gears (toothed gears) 16, 17, 19, 44 and the bearings 27, 30, 20, 21, 31, 48.

Various operation modes of the engine and the electric motor, that is, operation modes as the hybrid drive system 1, may be employed as necessary. As an example, when the vehicle starts off, the clutch is disconnected and the engine stopped so that the vehicle is started using only the torque from the electric motor 2. Once the vehicle speed reaches a predetermined speed, the engine is started and the vehicle is accelerated by the power from the engine and the electric motor. When the vehicle speed becomes a cruising speed, the electric motor goes into free rotation or is placed in a regeneration mode, and the vehicle travels using only the power from the engine. During deceleration or braking, the electric motor regenerates to charge a battery. Further, the vehicle may be started by the power from the engine using the clutch as a starting clutch, with the torque from the motor used as an assisting power.

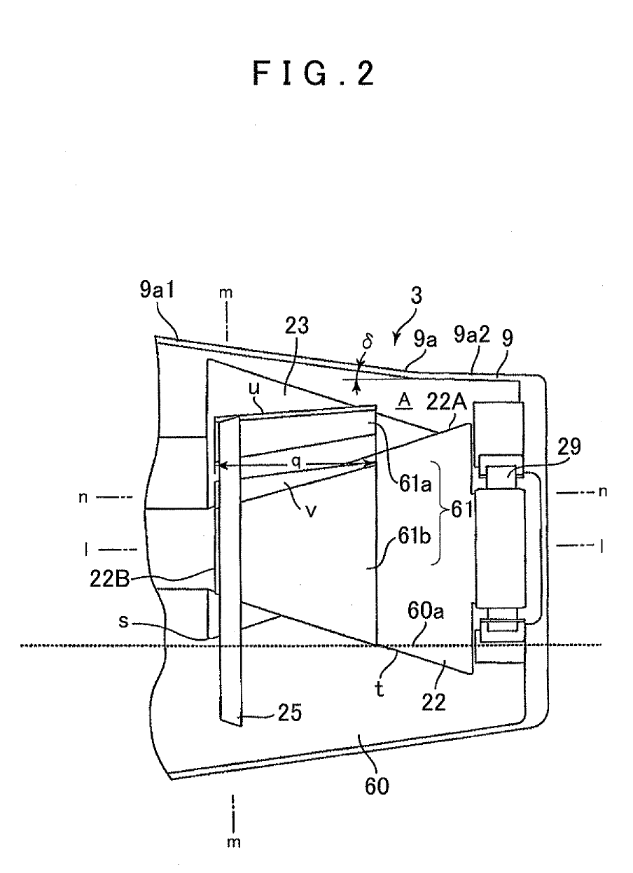

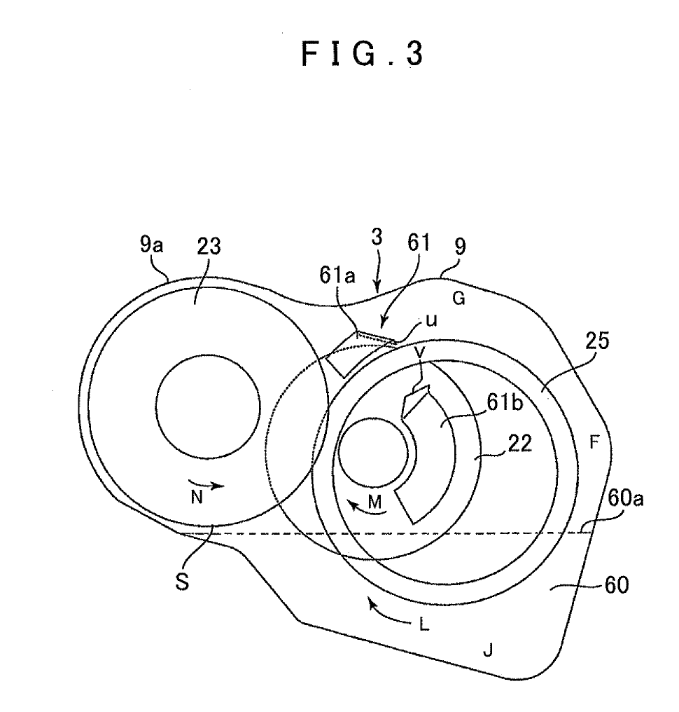

Next, the conical friction ring (cone ring) type continuously variable transmission device 3 according to the present invention will be described with reference to FIGS. 2 and 3. As explained earlier, the continuously variable transmission device 3 includes the input-side friction wheel 22, the output-side friction wheel 23, and the ring 25. Both friction wheels and the ring are formed from a metal such as steel. The friction wheels 22, 23 are disposed such that the axes l-l, n-n thereof are horizontal and mutually parallel, and have conical shapes whose inclined surfaces are linear. The ring 25 is provided interposed between opposing inclined surfaces. The ring 25 is disposed so as to surround one of the friction wheels, specifically, the input-side (first conical) friction wheel 22. A cross section of the ring 25 on a perpendicular plane to a circumferential direction thereof is substantially a parallelogram, and a rotational plane m-m of the ring 25 is set so as to be generally perpendicular to the axis l-l.

The cone ring type continuously variable transmission device 3 is accommodated in an oil-tight manner in the first space A with one end side and an entire circumferential side thereof covered by the bottomed cylindrical first case member 9, and an opening side of the first case member 9 closed by the partition 12. Both friction wheels are arranged staggered in the vertical direction such that the axis n-n of the output-side (second conical) friction wheel 23 is positioned above the axis l-l of the input-side (first conical) friction wheel 22 by a predetermined amount. The input-side friction wheel 22 is disposed with play thereabove and therebelow, and with play between it and the case member 9 on a side opposite the output-side friction wheel 23. The ring 25 surrounding the input-side friction wheel 22, as shown in FIG. 3, is disposed in a space between the input-side friction wheel and the case member 9, and the shift operation member (not shown) that moves the ring 25 in the axial direction is disposed spanning from a side space F and an upper space G.

A lower space J between the case member 9 and the input-side friction wheel 22 is an oil reservoir 60 (whose oil level is indicated by reference numeral 60a) for traction oil. The case member 9 extends along the output-side friction wheel so as to substantially surround three surfaces (an upper surface, a lower surface, and a side surface, excluding an input-side friction wheel side in FIG. 3) of the output-side (second conical) friction wheel 23. As shown in FIG. 2, an output-side friction wheel portion 9a of the case member 9 has an angle δ that is smaller than an inclination angle of the conical output-side friction wheel 23, and is formed of a conical shape 9a1 in an direction following the conical friction wheel and a cylindrical shape 9a2 on a distal end side thereof. The output-side friction wheel 23 is disposed such that a lower end s of a conical maximum diameter portion of the output-side friction wheel 23 is positioned above the oil level 60a, and so that the entire axial length of the output-side friction wheel 23 does not become submerged in the oil reservoir 60.

Meanwhile, the input-side friction wheel 22 is disposed such that a small diameter side 22B of the input-side friction wheel 22 is positioned above the oil level 60a over a predetermined length (q), and a large diameter-side portion 22A of the input-side friction wheel 22 becomes submerged in the oil reservoir 60. For example, the conical input-side friction wheel 22 is dipped in the oil reservoir 60 such that 50 to 65% of the entire length from the small diameter side thereof is positioned above the oil level 60a and 50 to 35% of the large diameter side is submerged in the oil reservoir 60. A lower end surface t of the input-side friction wheel 22 is provided with an oil guide 61 that corresponds to the small diameter side that is positioned above the oil level 60a. In other words, the oil guide 61 is disposed so as to extend the axial length q that corresponds to a portion not submerged in the oil reservoir 60 on the small diameter side of the input-side friction wheel 22. Given that it is the small diameter side, there is play between the case member 9 and the small diameter-side portion of the input-side friction wheel 22 on which the oil guide 61 is disposed. There is also no interference between the small diameter-side portion of the input-side friction wheel 22 and the shift operation member disposed in the spaces G, F. Consequently, sufficient installation space for the shift operation member is secured.

The oil guide 61 is formed of an upper oil guide 61a that is disposed above the small diameter side of the input-side friction wheel 22, and a side oil guide 61b that is disposed offset sideward of the small diameter side of the input-side friction wheel 22. The upper oil guide 61a is formed from a plate-like member. The upper oil guide 61a, above the input-side friction wheel 22, extends over the lateral predetermined length (partial region) q so as to follow the outer diameter side of the movement path of the ring 25. In addition, the upper oil guide 61a has a predetermined width set so as to follow an outer circumference of the ring. An end portion of the upper oil guide 61a in the width direction (a downstream-side end in the normal rotation direction of the ring) has a fold (u) such that oil is deflected toward the input-side friction wheel 22. The side oil guide 61b is similarly formed from a plate-like member. The side oil guide 61b, offset laterally (sideward) of the input-side friction wheel 22 inside the ring 25, extends over the same axial predetermined length q so as to follow the inclined surface of the input-side friction wheel. In addition, the side oil guide 61b has a predetermined width set so as to follow an outer circumferential surface of the input-side friction wheel. An end portion of the side oil guide 61b in the width direction (an upstream-side end in the normal rotation direction of the ring) has a fold (v) for receiving oil.

In the present conical friction ring (cone ring) type continuously variable transmission device 3, torque is transmitted from the input-side (first conical) friction wheel 22 to the output-side (second conical) friction wheel 23 through the ring 25. The ring 25 is moved in the axial direction by the shift operation member (not shown) to steplessly change a speed by changing a friction contact position of the friction wheels 22, 23. In addition, traction oil is interposed at the friction contact position, and torque is transmitted through the shear force of the oil under an extreme pressure condition. When the vehicle travels forward, the rotation of the input-side friction wheel 22 in an arrow M direction causes the ring 25 to rotate in an arrow L direction, and the output-side friction wheel 23 to rotate in an arrow N direction. In other words, during forward travel of the vehicle, the input-side and output-side friction wheels 22, 23 rotate such that opposing portions thereof move upward from below.

Oil raked up from the oil reservoir 60 by a rotation member is supplied to the friction contact surface between the ring 25 and the friction wheels 22, 23. Regardless of the position to which the ring 25 is moved to by the axial moving mechanism (shift operation member), a lower portion of the ring 25 is fully submerged in the oil reservoir 60. Consequently, the ring 25 is sufficiently cooled, and the rotation of the ring 25 in the arrow L direction causes the oil in the oil reservoir 60 to be lifted up and around, and carried to the contact portion between the ring 25 and the friction wheels 22, 23. However, the ring 25 has a narrow width and the amount of oil taken up by the ring is insufficient, particularly because the oil flows in a ring outer diameter direction due to a centrifugal force. Therefore, on a deceleration (U/D) side where the ring 25 contacts the small diameter side of the input-side friction wheel 22, an insufficient amount of oil tends to be supplied where the input-side friction wheel 22 contacts a ring inner circumferential surface.

Oil taken up by the ring 25 is scattered toward the upper oil guide 61a due to the centrifugal force. The upper oil guide 61a receives the oil, which drops down toward the input-side friction wheel 22 due to gravity. Accordingly, oil raked up by the ring 25 is guided toward the input-side friction wheel 22 by the upper oil guide 61a that is on the small diameter side of the input-side friction wheel 22. Further, the oil is guided to the side oil guide 61b and maintained along an outer circumferential surface on the small diameter side of the input-side friction wheel. Thus, in a high deceleration state where the ring 25 contacts the small diameter side 2213 of the input-side friction wheel 22, a condition disadvantageous for supplying oil to the contact surface occurs, wherein the small diameter-side portion of the friction wheel is separated from the oil reservoir 60, the transmission torque is large, and the oil tends to flow to the large diameter side along the outer circumferential surface of the friction wheel. However, as described above, the oil guide 61 enables oil to be accurately supplied.

Accompanying a start-off and increase in speed from a vehicle stop, the ring 25 moves from a maximum deceleration (U/D) position (a position shown in FIG. 2) in the direction of the large diameter side 22A of the input-side friction wheel 22 (rightward in FIG. 2). In the movement direction of the ring, oil is already guided to the contact outer circumferential surface of the input-side friction wheel 22 by the upper and side oil guides 61a, 61b and combined with a fresh supply of oil that accompanies the rotation of the ring 25. Consequently, a sufficient amount of oil for power transmission is supplied by the shear force under an extreme pressure condition to achieve smooth shifting and power transmission.

In a state where the ring 25 exceeds the position where the oil guide 61 is disposed (the predetermined length q) and moves toward the large diameter side 22A, the lower end portion t of the input-side friction wheel 22 becomes submerged in the oil reservoir and oil is directly supplied to the input-side friction wheel 22. Thus, even without the intervention of the oil guide 61, oil is sufficiently interposed between the ring 25 and the input-side friction wheel 22 so as to achieve continued smooth shifting and reliable power transmission.

On the other hand, the entire axial length of the output-side friction wheel 23 is not submerged in the oil reservoir 60, and no oil is supplied by the oil guide. However, as described earlier, oil adhered to the ring 25 is in a more easy-to-apply position due to the centrifugal force. Moreover, three sides of the output-side friction wheel 23 are surrounded by the case member 9a. Oil scattered by the rotation in the arrow N direction of the output-side friction wheel 23 is guided by the case member 9a and again supplied to and held on the outer circumferential surface of the output-side friction wheel. Accordingly, a sufficient amount of oil can be secured for the friction contact surface of the ring 25.

Thus, the cone ring type continuously variable transmission device 3 secures over an entire shift range thereof necessary and sufficient oil between the ring 25 and the input-side friction wheel 22, and between the ring 25 and the output-side friction wheel 23, such that smooth and reliable shifting and power transmission can be achieved. Further, only a portion of the large diameter side of the input-side friction wheel 22 and the ring 25 is submerged in the oil reservoir 60. Thus, the oil shear resistance with respect to the rotation member is small, power loss is small, and there is little reduction in transmission efficiency.

Note that, although the upper oil guide 61a and the side oil guide 61b are both provided as the oil guide 61, only one of these, such as only the upper oil guide, may be provided for example. The same also applies to a cone ring continuously variable transmission device in which the ring is disposed so as to surround the output-side friction wheel.

The above description concerns an embodiment in which the continuously variable transmission device is applied to a hybrid drive system. However, the present invention is not limited to this, and may be applied to a drive system other than a hybrid drive system, wherein, for example, another type of gear transmission device, such as a gear transmission device that serves as a reverse gear transmission device, or a planetary gear that separates and transfers a part of torque and combines the torque with an output from the continuously variable transmission device, may be used so as to expand the shift range of the continuously variable transmission device or distribute a part of the transferred torque. The present invention may also be used in a singular continuously variable transmission device. In such case, the present invention is preferably applied to transport machinery for an automobile or the like, but may be used in other power transmission devices for industrial machinery or the like as well.

The conical friction ring type continuously variable transmission device according to the present invention may be utilized as a power transmission device for any type of machinery, such as transport and industrial machinery, and is particularly well suited for application to a power transmission device for running and driving an automobile.

What is claimed is:

1. A conical friction ring type continuously variable transmission device comprising:
first and second conical friction wheels that are disposed on mutually parallel axes inside an oil-tight space and disposed such that a large diameter side and a small diameter side are opposite each other in an axial direction; and
a ring that is provided interposed between opposing inclined surfaces of the first and second conical friction wheels so as to surround the first conical friction wheel, wherein
power is transmitted by contact between the ring and the first and second conical friction wheels with oil interposed therebetween, and moving the ring in the axial direction steplessly changes a speed,
a portion of the ring is submerged in an oil reservoir in a lower portion of the space when the ring is moved to any position in the axial direction, and
an oil guide is disposed on only an axial partial region on the small diameter side of the first conical friction wheel, and guides oil raked up from the oil reservoir due to the rotation of the ring toward the first conical friction wheel.

2. The conical friction ring type continuously variable transmission device according to claim 1, wherein,
the oil guide comprises:
an upper oil guide that, above the first conical friction wheel, extends over a axial predetermined length so as to follow an outer diameter side of a movement path of the ring, and is formed of a predetermined width in an outer circumferential direction of the ring; and
a side oil guide that, offset sideward of the first conical friction wheel inside the ring, extends over the axial predetermined length so as to follow the inclined surface of the first conical friction wheel, and is formed of a predetermined width so as to follow an outer circumferential surface of the first conical friction wheel.

3. The conical friction ring type continuously variable transmission device according to claim 1, wherein
the first conical friction wheel has a portion in the axial direction on the large diameter side submerged in the oil reservoir.

4. The conical friction ring type continuously variable transmission device according to claim 3, wherein
the axial partial region is disposed so as to correspond to a position at which the first conical friction wheel is not submerged in the oil reservoir.

5. The conical friction ring type continuously variable transmission device according to claim 1, wherein
the conical friction ring type continuously variable transmission device is mounted in a vehicle, and a rotational direction is set such that, during forward travel of the vehicle, opposing portions of the first and second conical friction wheels move upward from below,
the axis of the second conical friction wheel is in a horizontal direction and positioned above the axis of the first conical friction wheel, and a lower end of the large diameter side of the second conical friction wheel is disposed so as to be positioned above an oil level of the oil reservoir, and
a case that forms the space accommodating an upper portion of the second conical friction wheel is formed of a conical shape and a cylindrical shape so as to surround the second conical friction wheel.

6. The conical friction ring type continuously variable transmission device according to claim 1, wherein
the first conical friction wheel is an input-side friction wheel, and the second conical friction wheel is an output-side friction wheel.

7. The conical friction ring type continuously variable transmission device according to claim 1, wherein
the oil is a traction oil.

8. The conical friction ring type continuously variable transmission device according to claim 2, wherein
the first conical friction wheel has a portion in the axial direction on the large diameter side submerged in the oil reservoir.

9. The conical friction ring type continuously variable transmission device according to claim 8, wherein
the axial partial region is disposed so as to correspond to a position at which the first conical friction wheel is not submerged in the oil reservoir.

10. The conical friction ring type continuously variable transmission device according to claim 9, wherein
the conical friction ring type continuously variable transmission device is mounted in a vehicle, and a rotational direction is set such that, during forward travel of the vehicle, opposing portions of the first and second conical friction wheels move upward from below,
the axis of the second conical friction wheel is in a horizontal direction and positioned above the axis of the first conical friction wheel, and a lower end of the large diameter side of the second conical friction wheel is disposed so as to be positioned above an oil level of the oil reservoir, and
a case that forms the space accommodating an upper portion of the second conical friction wheel is formed of a conical shape and a cylindrical shape so as to surround the second conical friction wheel.

11. The conical friction ring type continuously variable transmission device according to claim 10, wherein
the first conical friction wheel is an input-side friction wheel, and the second conical friction wheel is an output-side friction wheel.

12. The conical friction ring type continuously variable transmission device according to claim 11, wherein
the oil is a traction oil.

13. The conical friction ring type continuously variable transmission device according to claim 2, wherein
the conical friction ring type continuously variable transmission device is mounted in a vehicle, and a rotational direction is set such that, during forward travel of the vehicle, opposing portions of the first and second conical friction wheels move upward from below,
the axis of the second conical friction wheel is in a horizontal direction and positioned above the axis of the first conical friction wheel, and a lower end of the large diameter side of the second conical friction wheel is disposed so as to be positioned above an oil level of the oil reservoir, and
a case that forms the space accommodating an upper portion of the second conical friction wheel is formed of a conical shape and a cylindrical shape so as to surround the second conical friction wheel.

14. The conical friction ring type continuously variable transmission device according to claim 2, wherein
the first conical friction wheel is an input-side friction wheel, and the second conical friction wheel is an output-side friction wheel.

15. The conical friction ring type continuously variable transmission device according to claim 3, wherein
the conical friction ring type continuously variable transmission device is mounted in a vehicle, and a rotational direction is set such that, during forward travel of the vehicle, opposing portions of the first and second conical friction wheels move upward from below,
the axis of the second conical friction wheel is in a horizontal direction and positioned above the axis of the first conical friction wheel, and a lower end of the large diameter side of the second conical friction wheel is disposed so as to be positioned above an oil level of the oil reservoir, and
a case that forms the space accommodating an upper portion of the second conical friction wheel is formed of a conical shape and a cylindrical shape so as to surround the second conical friction wheel.

16. The conical friction ring type continuously variable transmission device according to claim 3, wherein
the first conical friction wheel is an input-side friction wheel, and the second conical friction wheel is an output-side friction wheel.

17. The conical friction ring type continuously variable transmission device according to claim 5, wherein
the first conical friction wheel is an input-side friction wheel, and the second conical friction wheel is an output-side friction wheel.

18. The conical friction ring type continuously variable transmission device according to claim 8, wherein
the conical friction ring type continuously variable transmission device is mounted in a vehicle, and a rotational direction is set such that, during forward travel of the vehicle, opposing portions of the first and second conical friction wheels move upward from below,
the axis of the second conical friction wheel is in a horizontal direction and positioned above the axis of the first conical friction wheel, and a lower end of the large diameter side of the second conical friction wheel is disposed so as to be positioned above an oil level of the oil reservoir, and
a case that forms the space accommodating an upper portion of the second conical friction wheel is formed of a conical shape and a cylindrical shape so as to surround the second conical friction wheel.

19. The conical friction ring type continuously variable transmission device according to claim 8, wherein
the first conical friction wheel is an input-side friction wheel, and the second conical friction wheel is an output-side friction wheel.

20. The conical friction ring type continuously variable transmission device according to claim 13, wherein
the first conical friction wheel is an input-side friction wheel, and the second conical friction wheel is an output-side friction wheel.
